(19) United States
(12) Patent Application Publication
(10) Pub. No.: US 2025/0317768 A1
(43) Pub. Date: Oct. 9, 2025

(54) COMMUNICATIONS SYSTEM INCLUDING BROADBAND BACKHAUL COMMUNICATION OF DIAGNOSTIC DATA AND RELATED METHODS

(71) Applicant: L3HARRIS GLOBAL COMMUNICATIONS, INC., Albany, NY (US)

(72) Inventors: Joshua C. OSTRANDER, Henrietta, NY (US); Thomas A. HENGEVELD, Greenfield Center, NY (US); Christopher J. OWEN, Pittsford, NY (US)

(21) Appl. No.: 18/915,212

(22) Filed: Oct. 14, 2024

Related U.S. Application Data
(60) Provisional application No. 63/574,842, filed on Apr. 4, 2024.

(51) Int. Cl. H04W 24/08; H04W 88/06

(52) U.S. Cl. CPC H04W 24/08; H04W 88/06

(57) ABSTRACT

A communications system may include a diagnostic server, a land mobile radio (LMR) having a first data rate, and a broadband backhaul radio (BBR) having a second data rate higher than the first data rate. The communications system may also include a controller configured to operate at least one application for communication via the LMR, store diagnostic information associated with the operation of the at least one application, and determine a trigger event. The controller may also be configured to communicate the diagnostic information to the diagnostic server via the BBR based upon the trigger event.

### RELATED APPLICATIONS

The present application claims the priority benefit of provisional application Ser. No. 63/574,842 filed on Apr. 4, 2024, the entire contents of which are herein incorporated by reference.

### TECHNICAL FIELD

The present invention relates to the field of communication, and, more particularly, to land mobile radio communication and related methods.

### BACKGROUND

A land mobile radio (LMR) communication system is a person-to-person (P2P) communication system. P2P communication may be performed using two-way radio transceivers which can be stationary, mobile, or portable.

A broadband backhaul radio (BBR) communicates using any of a number of a higher-speed and higher-capacity transmission technologies. In other words, a BBR communicates based upon the transmission of wide bandwidth data over a relatively high-speed connection, for example, a high-speed internet connection.

Oftentimes, it may be desirable to log events as they relate to operation of an LMR. A third-party support technician may be employed to retrieve or download any such log of events, which may be relatively large in size and time consuming in terms of collection. Moreover, any event logs may be communicated, for example, emailed, copy-and-pasted, or by way of screenshot, for analysis.

### SUMMARY

A communications system may include a diagnostic server, a land mobile radio (LMR) having a first data rate, and a broadband backhaul radio (BBR) having a second data rate higher than the first data rate. The communications system may also include a controller configured to operate at least one application for communication via the LMR, store diagnostic information associated with the operation of the at least one application, and determine a trigger event. The controller may also be configured to communicate the diagnostic information to the diagnostic server via the BBR based upon the trigger event.

In some embodiments, the communications system may also include a housing carrying the LMR, BBR, and controller. In other embodiments, the communications system may include a first housing carrying the LMR, a second housing carrying the BBR, and a wireless communications link between the LMR and the BBR, for example. The wireless communications link may include a Bluetooth link, for example.

The controller may be configured to scrub the diagnostic information for identifying information prior to communicating the diagnostic information. The controller may be configured to determine a communication quality of the BBR and communicate the diagnostic information based upon the communication quality exceeding a quality threshold, for example.

The trigger event may include at least one of user input corresponding to an event associated with operation of the at least one application, a user-settable trigger event associated with operation of the LMR, and a user-settable trigger event associated with operation of the at least one application. The BBR may include one of a cellular radio and a WiFi radio, for example.

A related method is directed to a method of communicating. The method may include using a controller to operate at least one application for communication via a land mobile radio (LMR) having a first data rate, and store diagnostic information associated with the operation of the at least one application. The method may also include using the controller to determine a trigger event, and communicate the diagnostic information to a diagnostic server via a broadband backhaul radio (BBR) having a second data rate higher than the first data rate based upon the trigger event.

### BRIEF DESCRIPTION OF THE DRAWINGS

FIG. 1 is a schematic diagram of a communications system in accordance with an embodiment.

FIG. 2 is a schematic operational diagram of the communications system of FIG. 1.

FIG. 3 is another schematic operational diagram of the communications system of FIG. 1.

FIG. 4 is a schematic block diagram of a portion of the communications system of FIG. 1.

FIG. 5 is a flow diagram illustrating operation of the controller of the communications system of FIG. 1.

FIG. 6 is a schematic block diagram in accordance with another embodiment.

FIG. 7 is a flow diagram illustrating operation of the controller of FIG. 6.

FIG. 8 is a schematic diagram of a communications system in accordance with another embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notation is used to indicate similar elements in alternative embodiments.

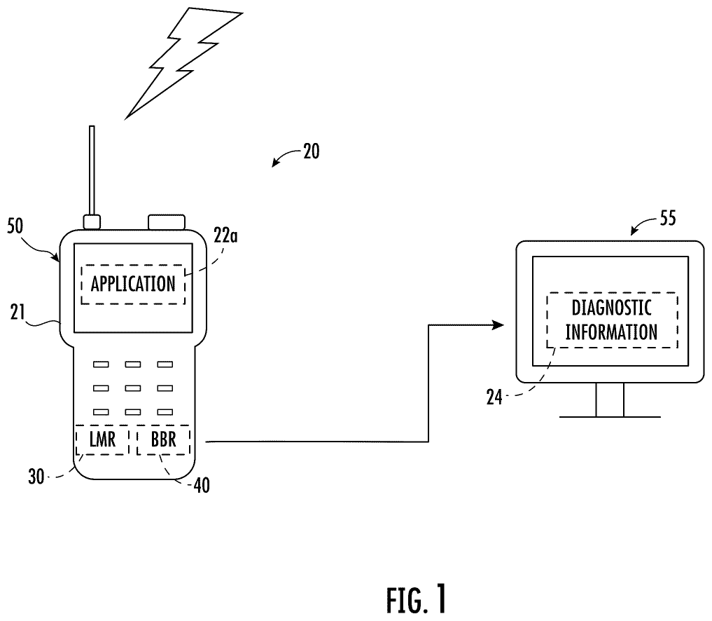

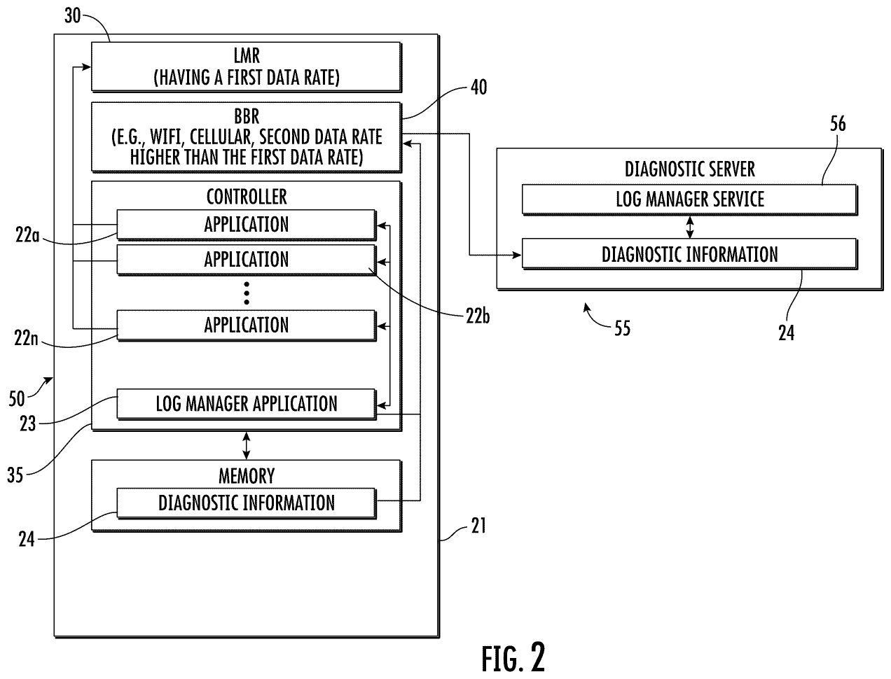

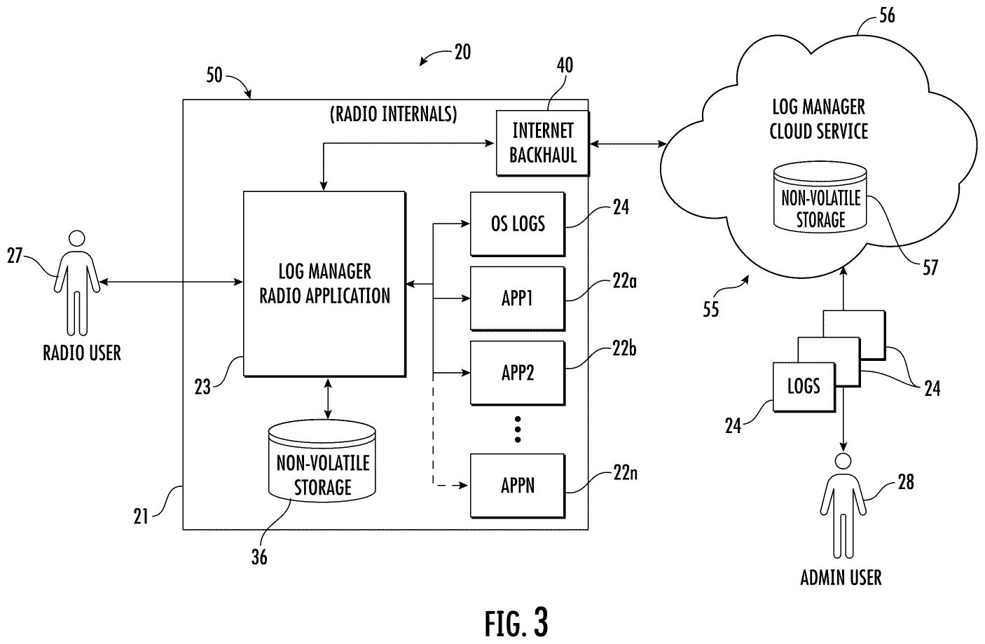

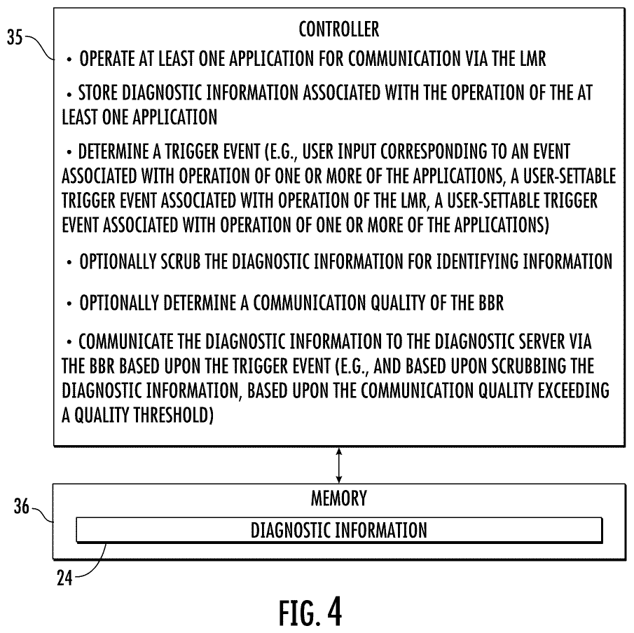

Referring initially to FIGS. 1-4, a communications system 20 includes a land mobile radio (LMR) 30. A radio user 27, for example, may use the LMR 30 to conduct push-to-talk (PTT) two-way communication with another user or users. The LMR 30 includes wireless communications circuitry to permit or facilitate two-way communication. As will be appreciated by those skilled in the art, the LMR 30 may operate in very-high frequency (VHF) bands, for example, 30-50 MHZ, 150-172 MHZ, and ultra-high frequency bands, for example, 450-470 MHz. Of course, the LMR 30 may operate in other and/or additional frequency bands. Similarly, the LMR 30 may operate based upon any one or more air interface protocols (e.g., Project 25). The LMR 30 may be embodied as a portable handheld radio, for example. In some embodiments, the LMR 30 may be a base station LMR or vehicle-coupled LMR. The LMR 30 has a first data rate associated therewith. As will be appreciated by those skilled in the art, a data rate of an LMR 30 is relatively slow and the capacity of an LMR system is likewise limited (i.e., narrowband). Thus, it may be desirable to limit communications of the LMR 30 to what may be considered mission critical communications, for example.

The communications system 20 also includes a broadband backhaul radio (BBR) 40. The BBR 40 includes circuitry to permit wireless communication (e.g., via the Internet, Internet Backhaul) using one or more of WiFi wireless communication and cellular (e.g., 4G, 5G, LTE, etc.) communication. In some embodiments, the BBR 40 may communicate via satellite. The BBR 40 has a second data rate associated therewith that is faster than the first data rate. In fact, the first data rate may be—0 bps for an LMR system that may not support data, such as, for example, an analog LMR system.

The LMR 30 and the BBR 40 are carried by a housing 21, for example, a single housing to define a mobile wireless communications device 50. The mobile wireless communications device 50 is illustratively in the form of a portable radio device similar to a standalone LMR. Those skilled in the art will appreciate that a mobile wireless communications device 50 that operates primarily as an LMR 30, but also includes a BBR 40, may be considered a converged LMR. The mobile wireless communications device 50 may be in another form, for example, a cellular phone or smartphone.

A controller 35 is carried by the housing 21 and is coupled to the LMR 30 and the BBR 40. The controller 35 cooperates with the LMR 30 and BBR 40 to perform operations, for example, wireless communications functions via the LMR and BBR, as will be described in further detail herein.

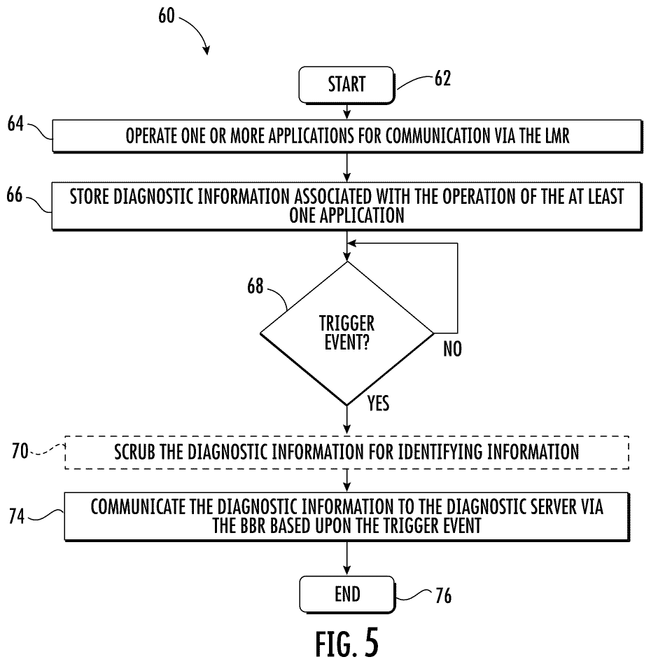

Referring additionally to the flowchart 60 in FIG. 5, beginning at Block 62, operations of the controller will now be described. At Block 64, the controller 35 operates one or more applications 22a-22n for communication via the LMR 30. For example, a given application 22a-22n may include a mission critical push-to-talk (MCPTT) application. Other and/or additional applications may be executed by the controller 35.

The controller 35, at Block 66, stores diagnostic information 24 associated with operation of the application 22a-22n, for example, in a memory 36 (e.g., non-volatile memory) coupled to the controller. More particularly, the controller 35 may operate a log manager application 23 to collect and store diagnostic information 24 relating to another application. The storage of diagnostic information 24 may be concurrent with operation of any of the applications 22a-22n, or may be initiated upon user input, for example. The controller 35, by way of the log manager application 23, may also store diagnostic information 24 relating to any operating system (e.g., OS logs) or instructions executed by the controller. The diagnostic information 24 may be stored in the memory 36 even though the mobile wireless communications device 50 may have been power-cycled.

The controller 35 determines a trigger event (Block 68). Exemplary trigger events may include any one or more of user input (e.g., manual input) corresponding to an event associated with operation of an application 22a-22n, a user-settable trigger event associated with operation of the LMR 30, and a user settable trigger event associated with operation of one or more of the applications. A trigger event may include establishing a communications connection with a diagnostic server 55 via the BBR 40. In other words, if communication via the BBR 40 was previously unavailable, once the connection can be established to the diagnostic server 55, a trigger event may be considered to have occurred. Other and/or additional trigger events may include time-of-day, capacity, size, or amount of diagnostic data 24, and/or activity of a given application 22a-22n.

Accordingly, upon a trigger event (Block 68), for example, any one of several trigger events, the controller 35 communicates the diagnostic information 24 to the diagnostic server 55 via the BBR 40 (Block 74). In other words, when there is a trigger event, the controller 35 cooperates with the BBR 40 to communicate the diagnostic information 24 to the diagnostic server 55 for diagnostic analysis.

The log manager application 23 cooperates with a corresponding log manager service 56 executed by the diagnostic server 55 to communicate or upload, via the BBR 40, the diagnostic data 24 (e.g., log files) to the diagnostic server. The log manager application 23 uses the BBR 40 (e.g., via the Internet, LTE, WiFi, etc.) to contact the log manager service 56. The diagnostic data 24 may be stored, for example, in a memory 57, for future analysis and/or download by the diagnostic server 55. As will be appreciated by those skilled in the art, the log manager service 56 executed by the diagnostic server 55 may permit an administrative user 28 to retrieve the diagnostic data 24 for analysis, and may provide other related capabilities (e.g., access control, notification, information partitioning). In some embodiments, the diagnostic server 55 may provide an application programming interface (API) to permit communication (e.g., function calls) between the log manager service 56 and the log manager application 23.

The controller 35 may optionally, at Block 70, scrub the diagnostic data 24 of identifying information before being communicated via the BBR 40 to the diagnostic server 55. This way, identifying information, for example, personal identifying information (PII), may be withheld for privacy, security, or other reasons while still permitting remote diagnostics to be performed. Other data that may be scrubbed may include domain information and/or location data. Operations end at Block 76.

As will be appreciated by those skilled in the art the communications system 20, and more particularly, the mobile wireless communications device 50, may advantageously provide over-the-air (OTA) diagnostic information or diagnostic log retrieval (e.g., especially over commercial or private cellular networks). A typical LMR 30 does not permit OTA communication of diagnostic information. Moreover, the present system 20 may permit OTA retrieval, for example, whereby the timing of diagnostic data upload is based upon the user, which may be desirable for users in mission critical situations. Additionally, the system 20 may also provide OTA retrieval where failure of the BBR 40 may result in a subsequent retry, with timing also under user control, along with OTA retrieval where operations may include an API for extensibility to other radio applications, for example.

Additionally, typical approaches to obtaining diagnostic information include connecting, via a wired or tethered connection, a support computer, for example, via an LMR debugging cable. Even after the wired connection has been made, a typical LMR is set into a factory mode which takes both engineering and technical assistance to complete. A user or engineer, for example, attempts to reproduce the user's issue in the hopes of noticing the issue while logging. Moreover, a set of commands is typically entered precisely using a terminal program, or the log or diagnostic data is not created. The log or diagnostic data may be copied from the USB drive of the radio or LMR to the PC, where it is then emailed or uploaded to diagnostic personnel. This process may take days and even months depending on how evasive the error or issue experienced. The present system 20 addresses these shortcomings and allows communication of diagnostic data 24 in a relatively short time period.

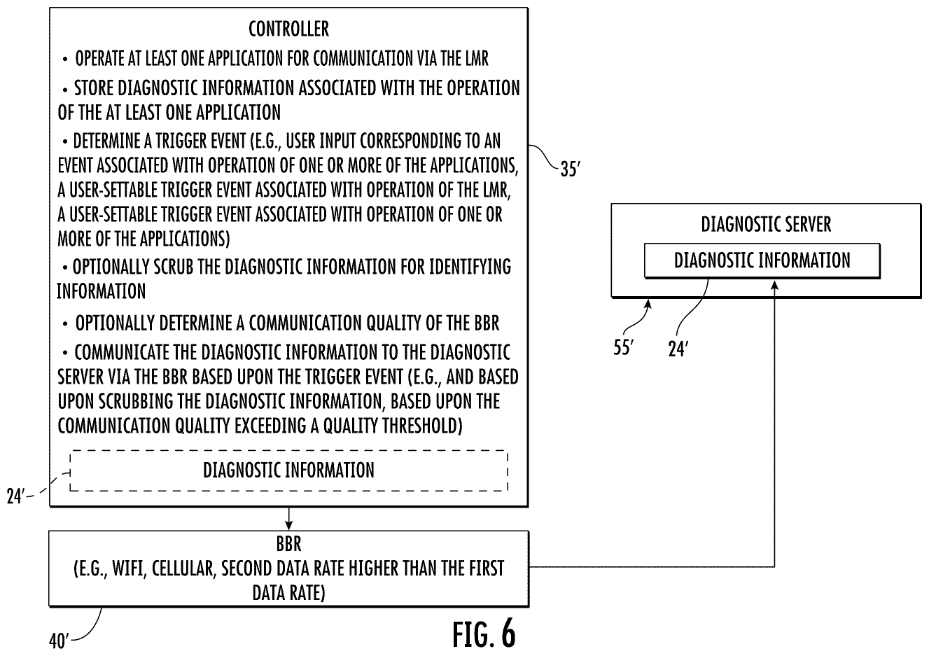

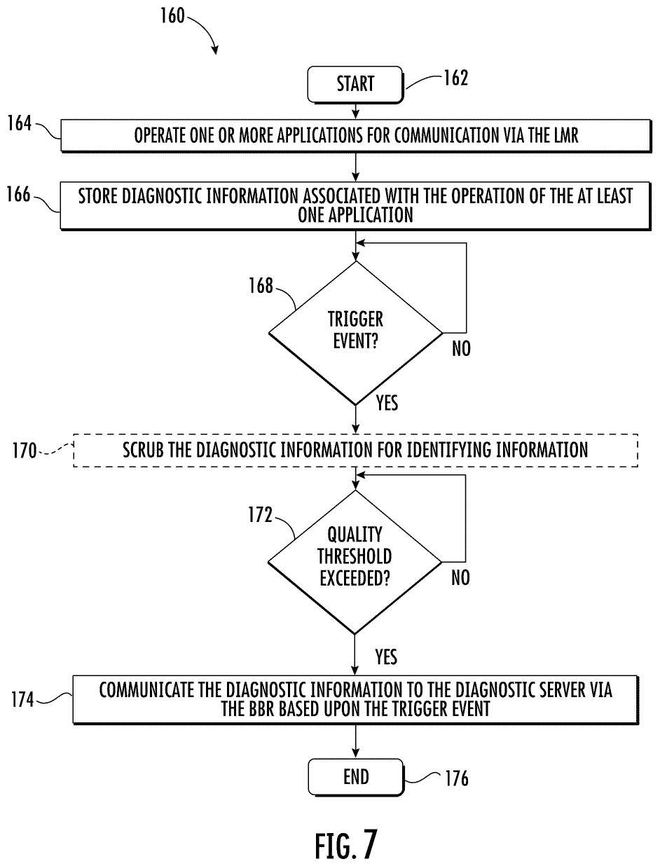

Referring now to FIG. 6 and the flowchart 160 in FIG. 7, beginning at Block 162 in another embodiment, the communication of the diagnostic data 24′ may be withheld until a desired communication quality has been exceeded. In particular, at Block 172, the controller 35′ determines whether a communication quality of the BBR 40′ exceeds a quality threshold. For example, the controller 35′ may determine whether the BBR 40′ can communicate with the diagnostic server 55′ (e.g., channel availability/connectivity), and/or whether a desired signal strength (e.g., signal-to-noise (SNR) ratio) has been met. If, at Block 172, the communication quality has been exceeded, operations continue at Block 174, which is similar to Block 74 above. If, at Block 172, the communication quality via the BBR 40′ has not been exceeded, the controller 35′ may poll or wait for the quality threshold to be exceeded by maintaining the diagnostic data 24′ in the memory. Operations at Blocks 164-170 are similar to operations at Block 64-70 described above. Operations end at Block 176.

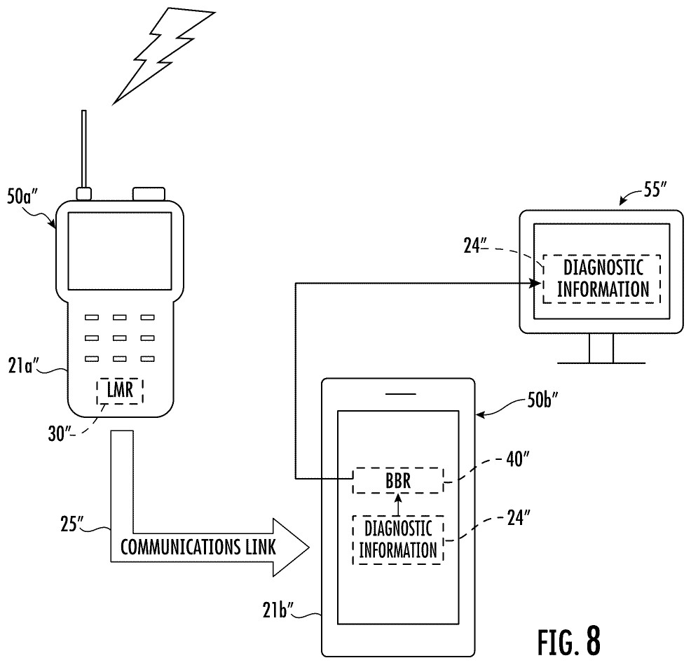

Referring now to FIG. 8, in another embodiment, the LMR radio 30″ is carried by a first housing 21a″ defining an LMR device 50a″. The BBR 40″ is carried by a second housing 21b″ defining a mobile phone or smartphone 50b″. A wireless communications link 25″ is between the LMR 30″ and the BBR 40″. The wireless communications link 25″ may include a short-range wireless communications link, for example, a Bluetooth link. Associated short-range wireless communications circuity (not shown) may be carried by the first and second housings 21a″, 21b″, for providing the wireless communications link 25″. The wireless communications link 25″ may include other and/or additional types of wireless communications links, for example, near-field communication (NFC).

The wireless communications link 25″ permits communication between the LMR 30″ and the BBR 40″. In the present embodiments, the controller may communicate the diagnostic data 24″ to a user's mobile phone or smartphone, as the BBR 40″, for example. Rather than the BBR 40″ being carried with the LMR 30″ in the first housing 21a″, the present embodiments advantageously use the wireless communications link 25″ (e.g., short-range wireless communications) to communicate the diagnostic data 24″ from the LMR 30″ to the BBR 40″. The BBR 40″ may operate as described above, for example, communicating the diagnostic data 24″ to the diagnostic server 55″ when a quality threshold has been exceeded. The LMR 30″ may also operate as described above, for example, also communicating the diagnostic data 24″ to the BBR 40″ when a quality threshold has been exceeded.

A related method is directed to a method of communicating. The method may include using a controller 35 to operate at least one application 22a-22n for communication via a land mobile radio (LMR) 30 having a first data rate and store diagnostic information 24 associated with the operation of the at least one application. The method may also include using the controller 35 to determine a trigger event and communicate the diagnostic information 24 to the diagnostic server 55 via a broadband backhaul radio (BBR) 40 having a second data rate higher than the first data rate based upon the trigger event.

While several embodiments have been described herein, it should be appreciated by those skilled in the art that any element or elements from one or more embodiments may be used with any other element or elements from any other embodiment or embodiments. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A communications system comprising:
a diagnostic server;
a land mobile radio (LMR) having a first data rate;
a broadband backhaul radio (BBR) having a second data rate higher than the first data rate;
a controller configured to
operate at least one application for communication via the LMR,
store diagnostic information associated with the operation of the at least one application,
determine a trigger event, and
communicate the diagnostic information to the diagnostic server via the BBR based upon the trigger event.

2. The communications system of claim 1 further comprising a housing carrying the LMR, BBR, and controller.

3. The communications system of claim 1 further comprising a first housing carrying the LMR, a second housing carrying the BBR, a wireless communications link between the LMR and the BBR.

4. The communications system of claim 3 wherein the wireless communications link comprises a Bluetooth link.

5. The communications system of claim 1 wherein the controller is configured to scrub the diagnostic information for identifying information prior to communicating the diagnostic information.

6. The communications system of claim 1 wherein the controller is configured to determine a communication quality of the BBR and communicate the diagnostic information upon the communication quality exceeding a quality threshold.

7. The communications system of claim 1 wherein the trigger event comprises at least one of user input corresponding to an event associated with operation of the at least one application, a user-settable trigger event associated with operation of the LMR, and a user-settable trigger event associated with operation of the at least one application.

8. The communications system of claim 1 wherein the BBR comprises one of a cellular radio and a WiFi radio.

9. A mobile wireless communications device comprising:
a housing;
a land mobile radio (LMR) carried by the housing and having a first data rate;
a broadband backhaul radio (BBR) carried by the housing and having a second data rate higher than the first data rate;
a controller carried by the housing and configured to
operate at least one application for communication via the LMR,
store diagnostic information associated with the operation of the at least one application,
determine a trigger event, and
communicate the diagnostic information to a diagnostic server via the BBR based upon the trigger event.

10. The mobile wireless communications device of claim 9 wherein the controller is configured to scrub the diagnostic information for identifying information prior to communicating the diagnostic information.

11. The mobile wireless communications device of claim 9 wherein the controller is configured to determine a communication quality of the BBR and communicate the diagnostic information upon the communication quality exceeding a quality threshold.

12. The mobile wireless communications device of claim 9 wherein the trigger event comprises at least one of user input corresponding to an event associated with operation of the at least one application, a user-settable trigger event associated with operation of the LMR, and a user-settable trigger event associated with operation of the at least one application.

13. The mobile wireless communications device of claim 9 wherein the BBR comprises one of a cellular radio and a WiFi radio.

14. A mobile wireless communications device comprising:
a first housing;
a second housing;
a land mobile radio (LMR) carried by the first housing and having a first data rate;
a broadband backhaul radio (BBR) carried by the second housing and having a second data rate higher than the first data rate;
a wireless communications link between the LMR and the BBR; and
a controller carried by the first housing and configured to
operate at least one application for communication via the LMR,
store diagnostic information associated with the operation of the at least one application,
determine a trigger event, and
communicate the diagnostic information to a diagnostic server via the BBR based upon the trigger event.

15. The mobile wireless communications device of claim 14 wherein the wireless communications link comprises a Bluetooth link.

16. The mobile wireless communications device of claim 14 wherein the controller is configured to scrub the diagnostic information for identifying information prior to communicating the diagnostic information.

17. The mobile wireless communications device of claim 14 wherein the controller is configured to determine a communication quality of the BBR and communicate the diagnostic information upon the communication quality exceeding a quality threshold.

18. The mobile wireless communications device of claim 14 wherein the trigger event comprises at least one of user input corresponding to an event associated with operation of the at least one application, a user-settable trigger event associated with operation of the LMR, and a user-settable trigger event associated with operation of the at least one application.

19. The mobile wireless communications device of claim 14 wherein the BBR comprises one of a cellular radio and a WiFi radio.

20. A method of communicating comprising:
using a controller to
operate at least one application for communication via a land mobile radio (LMR) having a first data rate,
store diagnostic information associated with the operation of the at least one application,
determine a trigger event, and
communicate the diagnostic information to the diagnostic server via a broadband backhaul radio (BBR) having a second data rate higher than the first data rate based upon the trigger event.

21. The method of claim 20 wherein the LMR, BBR, and controller are carried by a housing.

22. The method of claim 20 wherein the LMR and the controller are carried by a first housing and the BBR is carried by a second housing; and wherein using the controller comprises using the controller to wirelessly communicate the diagnostic information to the BBR via a wireless communications link.

23. The method of claim 20 wherein using the controller comprises using the controller to scrub the diagnostic information for identifying information prior to communicating the diagnostic information.

24. The method of claim 20 wherein using the controller comprises using the controller to determine a communication quality of the BBR and communicate the diagnostic information upon the communication quality exceeding a quality threshold.

25. The method of claim 20 wherein the trigger event comprises at least one of user input corresponding to an event associated with operation of the at least one application, a user-settable trigger event associated with operation of the LMR, and a user-settable trigger event associated with operation of the at least one application.
